(19) United States
(12) Patent Application Publication
(10) Pub. No.: US 2017/0231234 A1
(43) Pub. Date: Aug. 17, 2017

(54) CAKE SLICER SYSTEM

(71) Applicant: Dana Evans, Memphis, TN (US)

(72) Inventor: Dana Evans, Memphis, TN (US)

(21) Appl. No.: 15/434,048

(22) Filed: Feb. 15, 2017

Related U.S. Application Data
(60) Provisional application No. 62/295,172, filed on Feb. 15, 2016.

(51) Int. Cl. A21C 15/04; B26D 3/24

(52) U.S. Cl. CPC A21C 15/04; B26D 3/245

(57) ABSTRACT

A cake slicer system being a cake slicer assembly having a center post including a blade stabilizing circle and a plurality of detachable cutting members for enabling a user to equally slice desserts of varying sizes. The center post with the blade stabilizing circle allows for the application of a downward pressure upon the cake slicer assembly as to force the detachable cutting members downwardly through a dessert.

### CROSS REFERENCE TO RELATED APPLICATION

The present application is related to and claims priority to U.S. Provisional Patent Application No. 62/295,172 filed Feb. 15, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of cutting tools and more specifically relates to a cake slicer system.

2. Description of Related Art

Slicing cakes, pies, and other desserts can be a difficult process. People often estimate where to slice the dessert and may end up making one piece bigger or smaller than another. Handing out unequal portions of cake or pie can be upsetting to guests or customers. Some cake slicing tools can be difficult to use, especially if a user made desserts that differ in sizes. A suitable solution is desired.

U.S. Pat. No. 2,403,190 to Alfredo J Parraga relates to a cake cutter. The described cake cutter includes a cake cutter. The primary object of the invention is to provide a cake cutter that is of strong and rigid construction, capable of being readily and economically manufactured, and highly efficient in use. Generally described, the present cutter includes a circular frame having a plurality of equally spaced radial cutting elements mounted therein, and means to facilitate the application of a downward pressure upon the frame so as to force the cutting elements downwardly through the cake.

### BRIEF SUMMARY OF THE INVENTION

In view of the foregoing disadvantages inherent in the known cutting tools art, the present disclosure provides a novel cake slicer system. The general purpose of the present disclosure, which will be described subsequently in greater detail, is to provide a dessert slicing hand tool capable of slicing cakes, pies, and other desserts into equal pieces.

A cake slicer system is disclosed herein. The cake slicer system includes a cake slicer assembly having a center post, a blade stabilizing circle, and a plurality of detachable cutting members. The center post may comprise insert receivers for independently receiving each of the plurality of detachable cutting members. The insert receivers are equidistantly separated (vertically in relation to a horizontally-placed cake or other comestible) allowing for precision cutting of a cake or other dessert into equal slices. The plurality of detachable cutting members may comprise twelve of detachable cutting members which may be interchangeably inserted into the insert receivers for cutting a specific amount of equal slices of dessert. The plurality of detachable cutting members are equidistantly separated allowing for even (vertical) slicing. The plurality of detachable cutting members comprise foldable blades. The foldable blades may be dishwasher safe allowing for ease of washing.

The blade stabilizing circle includes a handle on a top surface of the blade stabilizing circle for allowing for the application of a downward pressure (user manually-manipulated) upon the cake slicer assembly and manipulation of the cake slicer assembly. The blade stabilizing circle may comprise a circular disc profile. The blade stabilizing circle is attached to a top end of the center post. The plurality of detachable cutting members may comprise a height of approximately 4 inches configured to cut desserts of varying heights and sizes. The plurality of detachable cutting members comprise a substantially rectangular profile. The cake slicer assembly may comprise a circular profile for cutting desserts having a circular profile such as cakes and pies. The cake slicer assembly enables a user to equally slice desserts of varying sizes (circumference) and the center post allowing for the application of a downward pressure upon the cake slicer assembly as to force the detachable cutting members downwardly through a dessert providing equally sliced portions (also works on different height comestibles).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a cake slicer system, constructed and operative according to the teachings of the present disclosure.

FIG. 1 is a front perspective view of the cake slicer system during an ‘in-use’ condition, according to an embodiment of the disclosure.

FIG. 2 is a perspective view of the cake slicer system of FIG. 1, according to an embodiment of the present disclosure.

FIG. 3 is a perspective view of the cake slicer system of FIG. 1, according to an embodiment of the present disclosure.

FIG. 4A is a perspective view of the cake slicer system of FIG. 1, according to an embodiment of the present disclosure.

FIG. 4B is a perspective view of the cake slicer system of FIG. 1, according to an embodiment of the present disclosure.

FIG. 4C is a perspective view of a detachable cutting member of FIG. 1, according to an embodiment of the present disclosure.

FIG. 5 is a top view of the cake slicer system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relates to a cutting tool and more particularly to a cake slicer system as used to improve the cutting of desserts.

Generally, many people eat desserts such as cakes, and pies. These may be difficult to slice using conventional means. The present invention provides users with a dessert slicing hand tool capable of slicing cakes, pies, and other desserts into equal pieces and as such virtually eliminates the worry of one guest at a birthday party, holiday party, picnic, wedding, and the like, getting a larger slice of cake than another person. It utilizes foldable blades in order to adapt to how large the dessert is, allowing users to cut up desserts in 12 pieces or less and preferably features dishwasher safe materials in order to make the device easy-to-clean and maintain.

The present invention offers an easy, efficient, and convenient method for slicing numerous desserts into equal slices. Cake slicer system is a handheld dessert cutting tool capable of cutting cakes, pies, and other desserts into multiple equal portions. The device is comprised of a circular unit with detachable blades, enabling users to slice desserts of different sizes. The cake slicer system can be exceptionally useful for those cutting desserts at birthday parties, church events, weddings, work parties, and bake sales. Users can simply press the slicer down on the dessert in order to slice it into equal pieces. The tool may be able to slice up to 12 equal portions of dessert at once. Cake slicer system can be constructed using metal, plastic, and other suitable dishwasher safe materials. The device may be available in numerous colors and designs, each suited to accommodate user needs and preferences.

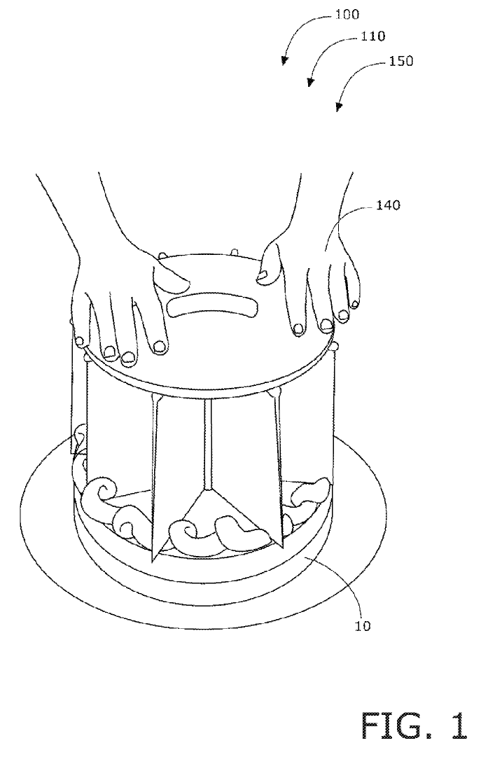

Referring now more specifically to the drawings by numerals of reference, there is shown in FIGS. 1-5, various views of a cake slicer system 100. FIG. 1 shows a cake slicer system 100 during an ‘in-use’ condition 150, according to an embodiment of the present disclosure. As illustrated, the cake slicer system 100 may include a cake slicer assembly 110 having a center post 120 with a blade stabilizing circle 126 and a plurality of detachable cutting members 134 for enabling a user 140 to equally slice desserts 10 of varying sizes. The center post 120 allows for the application of a downward pressure upon the cake slicer assembly 110 as to force the detachable cutting members 134 downwardly through a dessert 10.

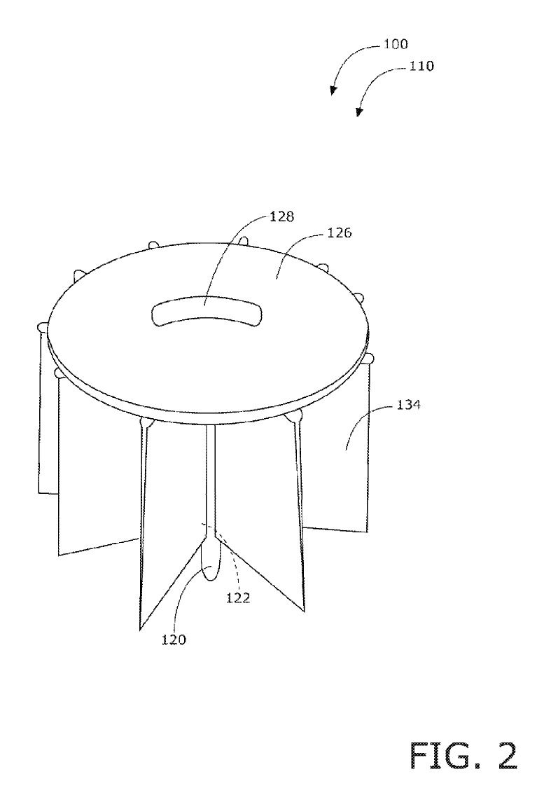

FIG. 2 shows a perspective view of the cake slicer system 100 of FIG. 1, according to an embodiment of the present disclosure. As above, the cake slicer system 100 may include a cake slicer assembly 110 having a center post 120 with a blade stabilizing circle 126 and a plurality of detachable cutting members 134. The center post 120 comprises insert receivers 122 for independently receiving each of the plurality of detachable cutting members 134. The insert receivers 122 are equidistantly separated.

The plurality of detachable cutting members 134 comprises at least two of the detachable cutting members 134 and a maximum of twelve of the detachable cutting members 134. Other amounts of detachable cutting members 134 may be used. The plurality of detachable cutting members 134 are equidistantly separated allowing for even slicing. The plurality of detachable cutting members 134 comprise foldable blades. The foldable blades are dishwasher safe. Cake slicer system 100 may be constructed using metal, plastic, and other suitable dishwasher safe materials. The blade stabilizing circle 126 comprises a handle on a top surface of the blade stabilizing circle for allowing for the application of a downward pressure upon the cake slicer assembly 110. The blade stabilizing circle 126 comprises a circular disc profile and is attached to a top end of the center post 120.

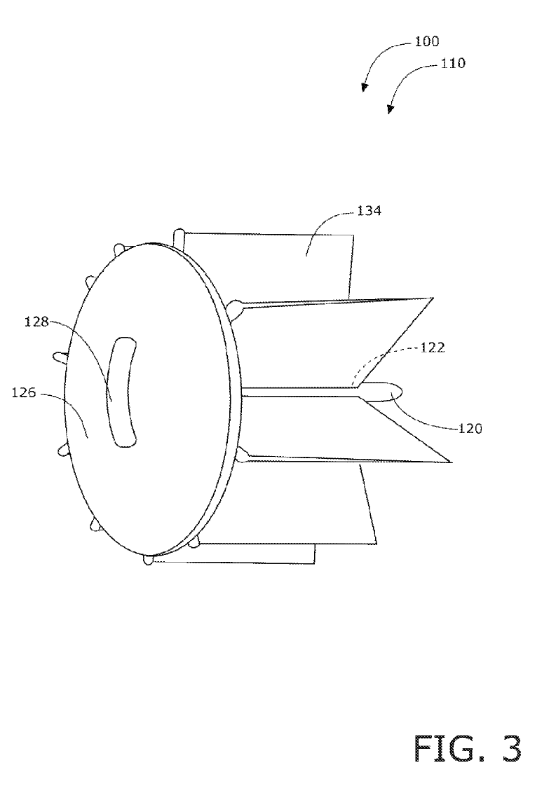

FIG. 3 shows a perspective view of the cake slicer system 100 of FIG. 1, according to an embodiment of the present disclosure. As above, the cake slicer system 100 may include a plurality of detachable cutting members 134 comprising a maximum height of 5 inches and a minimum height of 4 inches allowing for slicing of desserts 10 having various heights. Other heights may be used, but those mentioned are preferred. The plurality of detachable cutting members 134 comprise a substantially rectangular profile. The cake slicer assembly 110 may comprise a circular profile for cutting desserts 10 having a circular profile such as pies and cakes. Square—and other shaped—versions may be used.

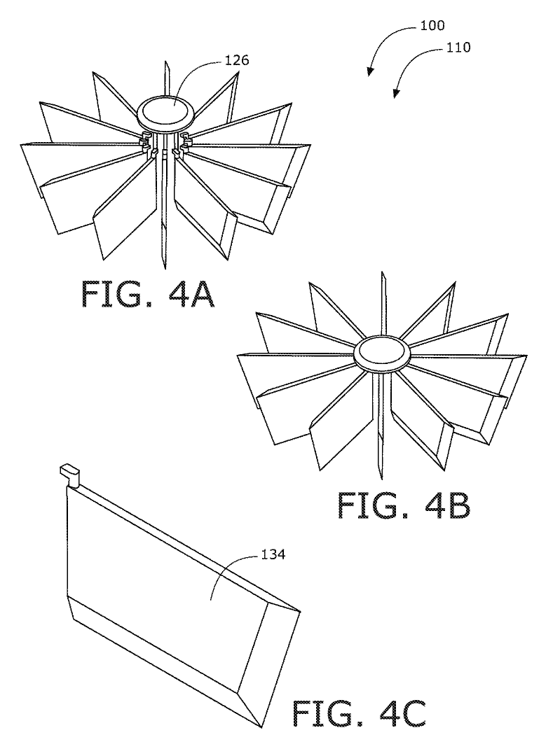

FIG. 4 shows a perspective view of the cake slicer system 100 of FIG. 1, according to an embodiment of the present disclosure. As above, the cake slicer system 100 may include a cake slicer assembly 110 having a center post 120, a blade stabilizing circle 126, and a plurality of detachable cutting members 134. The center post 120 may comprise insert receivers for independently receiving each of the plurality of detachable cutting members 134. The insert receivers are equidistantly separated allowing for precision cutting of a cake or other dessert into equal slices. In a most preferred embodiment, the cake slicer assembly 110 comprises twelve of the detachable cutting members 134 which may be interchangeably inserted into the insert receivers for cutting a specific amount of equal slices of dessert 10. The tool may be able to slice up to 12 equal portions of dessert 10 at once. The device utilizes foldable blades in order to adapt to how large the dessert is, allowing users to cut up desserts 10 in 12 pieces or less and preferably features dishwasher safe materials in order to make the device easy-to-clean and maintain.

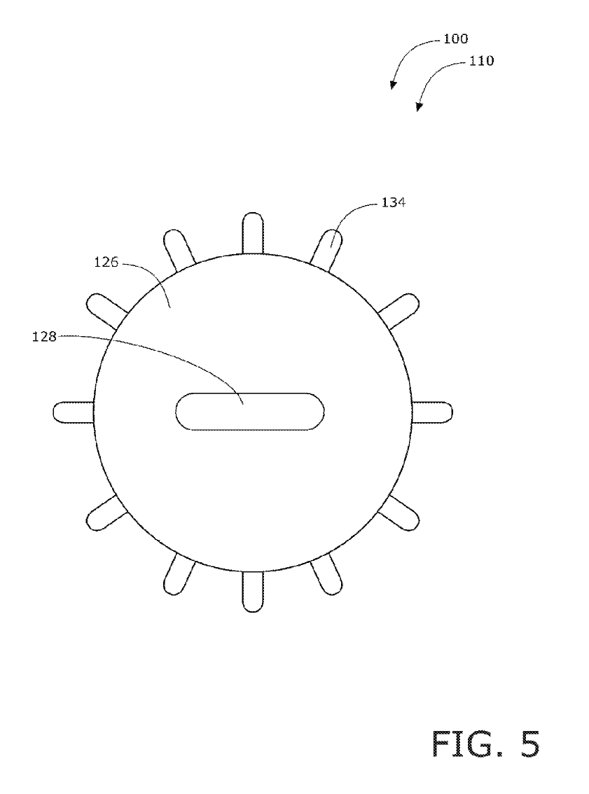

FIG. 5 shows a top perspective view of the cake slicer system 100 of FIG. 1, according to an embodiment of the present disclosure. As above, the cake slicer system 100 may include a blade stabilizing circle 126 includes a handle 128 on a top surface of the blade stabilizing circle 126 for allowing for the application of a downward pressure upon the cake slicer assembly 110 and manipulation of the cake slicer assembly 110. The blade stabilizing circle 126 may comprise a circular disc profile. The blade stabilizing circle 126 is attached to a top end of the center post 120. The plurality of detachable cutting members 134 may comprise a height of approximately 4 inches configured to cut desserts 10 of varying heights and sizes. The plurality of detachable cutting members 134 comprise a substantially rectangular profile.

According to one embodiment, the cake slicer system 100 may be arranged as a kit. The kit may include wherein the cake slicer system 100 is arranged as a kit including; a center post 120, a blade stabilizing circle 126, and a plurality of interchangeable detachable cutting members 134. The instructions may detail functional relationships in relation to the structure of the cake slicer system 100 (such that the cake slicer system 100 can be used, maintained, or the like, in a preferred manner).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cake slicer system, the system comprising:
a cake slicer assembly having,
a center post having a blade stabilizing circle and a plurality of detachable cutting members for enabling a user to equally slice desserts of varying sizes, the center post allowing for the application of a downward pressure upon the cake slicer assembly as to force the detachable cutting members downwardly through a dessert.

2. The cake slicer system of claim 1, wherein the center post comprises insert receivers for independently receiving each the plurality of detachable cutting members.

3. The cake slicer system of claim 1, wherein the plurality of detachable cutting members comprises at least two of said detachable cutting members.

4. The cake slicer system of claim 3, wherein the plurality of detachable cutting members comprises a maximum of twelve of said detachable cutting members.

5. The cake slicer system of claim 1, wherein the plurality of detachable cutting members are equidistantly separated allowing for even slicing.

6. The cake slicer system of claim 5, wherein the plurality of detachable cutting members comprise foldable blades.

7. The cake slicer system of claim 6, wherein the foldable blades are dishwasher safe.

8. The cake slicer system of claim 1, wherein the blade stabilizing circle comprises a handle on a top surface of the blade stabilizing circle for allowing for the application of a downward pressure upon the cake slicer assembly.

9. The cake slicer system of claim 8, wherein the blade stabilizing circle comprises a circular disc profile.

10. The cake slicer system of claim 9, wherein the blade stabilizing circle is attached to a top end of the center post.

11. The cake slicer system of claim 1, wherein the plurality of detachable cutting members comprises a maximum height of 5 inches.

12. The cake slicer system of claim 11, wherein the plurality of detachable cutting members comprises a minimum height of 4 inches.

13. The cake slicer system of claim 12, wherein the plurality of detachable cutting members comprises a height of approximately 4 inches.

14. The cake slicer system of claim 1, wherein the plurality of detachable cutting members comprise a substantially rectangular profile.

15. The cake slicer system of claim 2, wherein the insert receivers are equidistantly separated.

16. The cake slicer system of claim 1, wherein the cake slicer assembly comprises a circular profile for cutting desserts having a circular profile.

17. A cake slicer system, the system comprising:
a cake slicer assembly having;
a center post
a blade stabilizing circle; and
a plurality of detachable cutting members;
wherein the center post comprises insert receivers for independently receiving each the plurality of detachable cutting members;
wherein the insert receivers are equidistantly separated;
wherein the plurality of detachable cutting members comprises twelve of said detachable cutting members;
wherein the plurality of detachable cutting members are equidistantly separated allowing for even slicing;
wherein the plurality of detachable cutting members comprise foldable blades;
wherein the foldable blades are dishwasher safe;
wherein the blade stabilizing circle comprises a handle on a top surface of the blade stabilizing circle for allowing for the application of a downward pressure upon the cake slicer assembly;
wherein the blade stabilizing circle comprises a circular disc profile;
wherein the blade stabilizing circle is attached to a top end of the center post;
wherein the plurality of detachable cutting members comprises a height of approximately 4 inches;
wherein the plurality of detachable cutting members comprise a substantially rectangular profile;
wherein the cake slicer assembly comprises a circular profile for cutting desserts having a circular profile; and
wherein the cake slicer assembly enables a user to equally slice desserts of varying sizes, the center post allowing for the application of a downward pressure upon the cake slicer assembly as to force the detachable cutting members downwardly through said dessert, said dessert comprising a cake.

18. The system of claim 17, further comprising set of instructions; and
wherein the cake slicer system is arranged as a kit including;
said center post;
said blade stabilizing circle; and
said plurality of interchangeable detachable cutting members.
